(19) United States
(12) Patent Application Publication
(10) Pub. No.: US 2009/0319404 A1
(43) Pub. Date: Dec. 24, 2009

(54) METHOD FOR AUTOMATICALLY CLASSIFYING MONEY TRANSFERS MADE ON A BANK ACCOUNT

(76) Inventor: Nicolas Duchamp, Luxembourg (LU)

Correspondence Address: LAW OFFICES OF JAMES E. WALTON, PLLC, 1169 N. BURLESON BLVD., SUITE 107-328, BURLESON, TX, 76028, US

(21) Appl. No.: 12/489,546

(22) Filed: Jun. 23, 2009

(30) Foreign Application Priority Data
Jun. 24, 2008 (EP) 08158871.7

(51) Int. Cl. G06Q 10/00; G06Q 40/00

(52) U.S. Cl. 705/30

(57) ABSTRACT

A method for automatically classifying the transactions on a bank account includes mapping the identification codes of the firms with which the transactions are operated with the sectorial code of each firm and to map these sectional codes with categories of the transactions. This allows an automatic classification of the expenses of an individual. The transactions are summed in each category for a predetermined period of time and can be therefore presented in an optimized fashion to the bank account's holder. These sums can be compared to average values or corresponding values of the same individual for a preceding period of time. The result of the comparison can be expressed by a number and/or a sign.

The present application claims priority to European Patent Application No. 08158871.7 filed Jun. 24, 2008, the entire content of which is hereby incorporated by reference.

### BACKGROUND

1. Field of the Invention

The present application is directed to a method for automatically classifying the money transactions operated on a bank account, more particularly, to the automatic generation of reports of the expenses and credits of a personal bank account on a predetermined period of time. The present application is also directed to a data treatment process, including automatically classifying each expense of a bank's client in relevant expenses types or categories. The word “bank” can be interpreted as “bank or any financial institution.”

2. Description of Related Art

U.S. Pat. No. 5,748,908 discloses a method of automatic classification and categorization of consumer and business expenditures activated by a unique classification card. This card initializes a transaction terminal only once prior to the first classified sales transaction. Subsequently, each input data amount from credit/debit card sales transactions will be classified accordingly. These categorized amounts will then be further processed by a credit/debit card issuer. The classification card is unique and specific of each merchant and features the merchant's name and a binary sequential code of a specific expenditure classification (relative to the products or services he sells) and the merchant's point of sales terminal serial number. This permits an automatic categorization of all expenses made at a merchant under the conditions that (i) the payment is made by credit/debit card, (ii) the merchant has a classification card according to the teaching of this document, and (iii) the classification card is inserted in the terminal prior the credit/debit card for the payment.

These conditions are quite limiting in the sense that the expenses made by other means than with a credit/debit card are not categorized and that only the expenses made at merchants having a classification card will be categorized.

US 2004/0215565 A1 is directed to an interactive electronic data processing software utility banking system which integrates individual account transactions into running balance statements and budget reports. It requires from the user to interactively categorize all account transactions and allows the user to customize, change or create categories.

US 2007/0198409 A1 addresses the reporting of bank account statements to the account holder by e-mail but fails to consider any categorization of the transactions.

The document WO0177933A1 proposes a method to classify the expenses and incomes for a user. In this method, the banks or the merchants give a sectorial code (the “SIC” code) for each payment transaction by card or for any other electronic payment. This information is then used to generate an expense type. But the WO0177933A1 method does not explain how the sectorial code would be generated by the bank. The WO0177933A1 method assumes that the bank generates these sectorial codes, but does not show the process to generate them. In the WO0177933A1 method, the user has to generate manually an expense type while paying with a check. When paying with a check, the expense type is not generated through an automatic method but manually. Alternatively, an individual person who wants to have an analytical overview of its current expenses in its day-to-day life has to use a specific software (for example the software Microsoft Money) and has to enter manually or semi-manually its expenses in the software. In a second time the software permits to produce graphics and comparisons between one quarter and the previous one or between one quarter and a target budget.

### SUMMARY

The present disclosure seeks to solve the above mentioned problems by providing a method for automatically classifying transactions made on a bank account with a debtor or creditor firm, the method comprising, for each transaction:
identifying the public registration code of the firm with which the transaction is made, the code being a unique identification code of the firm and available to the transaction data;
identifying a public sectorial code of the firm which identifies the sectorial activity of the firm;
mapping the transaction with the identification code and the sectorial code; and assigning a category to the transaction based on the sectorial code assigned thereto.

Compared to the WO0177933A1 method, the present disclosure provides a process to generate automatically a sectorial code (the “NAF” code in France, or the “NAICS” code in the USA). To generate this sectorial code automatically, the bank has to maintain constantly a very large database with all merchants through the country. This database contains all the identifications codes for the merchants (the SIREN codes, in France), with the sectorial codes that are associated. This kind of data must be paid by the bank to public or private data holders, and these data evolve when new merchants are created in the country. The SIREN code is received by the bank for each transaction, and identifies the merchant for this transaction. The bank has to transform this identification code into a sectorial code. The step that introduces a process using SIREN codes to identify the merchants and to give then a relevant sectorial code is not disclosed in the WO0177933A1 method.

If you consider the WO0177933A1 method, the bank has to generate the sectorial codes for every expense and therefore for every firm and every shop in the country, which makes the procedure very hard to implement and very expensive—almost impossible in fact. The WO0177933A1 method also suggest that every firm and every shop in the country can generate the sectorial codes, which is very hard to implement as we can imagine in any country of the world. In comparison, the present method suggests that the bank asks for a public list of the whole firms with their sectorial codes. This data exist and can be bought by any bank, even small banks. With the present method, the bank has just to use this list and has no sectorial codes to generate manually. This is why the present method is economically and physically much easier and cheaper to implement compared to the WO0177933A1 method.

Preferably a category list is mapped with a public sectorial code list in order to automatically assign a category to each transaction.

Preferably the mapping between some sectorial codes and some categories is conditioned by the amount of the transaction and/or the debit or credit nature of the transaction.

In addition, the document WO0177933A1 does not suggest that the amount of the transaction can be used to classify the transaction into an expense type. The step that introduces the amount of the transaction as a last classification step provides a further improvement of the automatic classification.

In a preferred embodiment, a subtype list is mapped with a public sectorial code list and the automatic assignment of a category to a transaction is based on the subtype assigned to the transaction.

Still in a preferred embodiment, a category list is mapped with the subtype list.

Still in a preferred embodiment, the mapping between the category list and the subtype list is dependent on the amount of the transaction and/or the debit or credit nature of the transaction.

Generally, the transactions are debits of the bank account representing the expenses of the account's holder.

The transaction can comprise credit/debit card payments, electronic payments, transfers and automated payments.

The mapping between some sectorial codes and some category codes can be conditioned by the amount of the transaction.

The mapping between some sectorial codes and some category codes can be conditioned by the debit or credit nature of the money transfer.

The method can comprise the additional step of summing by category the amounts of the transactions for a predetermined period of time.

Preferably the sums of the transactions by category are compared with the corresponding sums of one or more preceding periods.

Preferably the sums of the transactions by category are compared with corresponding average results.

In a preferred embodiment the average results to which the sums of the transactions are compared by category correspond to the summed transactions of a virtual average person sharing with the bank account's holder a series of common or similar features.

Preferably the features shared with the virtual average person are comprised in the following not exhaustive list: age, gender, professional activity category, family situation, place of living, health state.

The features shared with the virtual average person can be categorized for the purpose of matching with the bank account's holder.

The comparison between the sums of the transactions by category with corresponding amounts can be expressed by means of at least a number and/or a sign for each category.

The method can comprise the additional step that an electronic report is generated and that the categorizing of the transactions can be manually modified.

The present disclosure provides a method that would permit the bank to generate automatically this kind of reports every quarter for example.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 shows a block diagram illustrating the process of the disclosed method through the different tables; and

FIGS. 2-4 show different sections of a report which is generated for a given period (in this case the third quarter of 2008) in accordance with the present disclosure.

### DETAILED DESCRIPTION OF THE PREFERRED EMBODIMENT

Disclosed herein is a new data treatment process. The aim is to use the identification code of a firm (the SIREN code in France, for example) that is transmitted by the debtor's bank to the client's bank for each transaction. For each client, the bank has accumulated every expense with the SIREN code of the debtor.

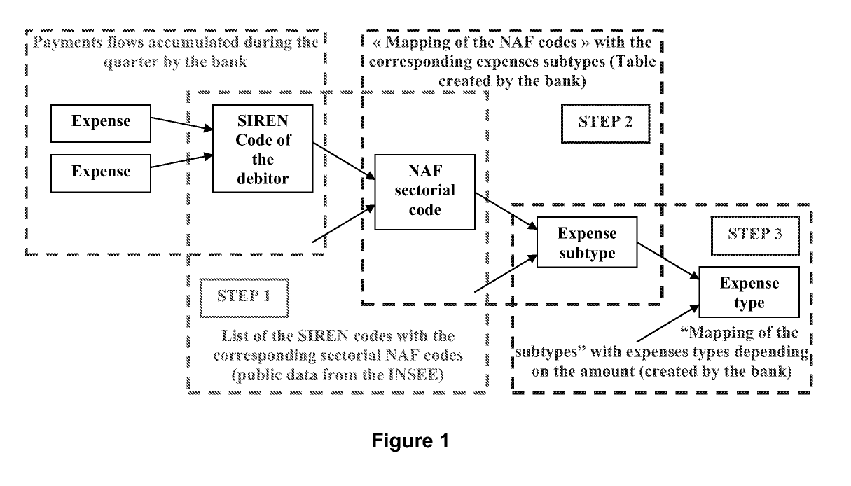

FIG. 1 illustrates the principle where the steps 1, 2 and 3 which are described more in details here below are schematically represented by dashed boxes.

In a first step, the bank has to ask for an updated list of every firms in the country, with the corresponding SIREN code and the corresponding sectorial code (the NAF code in France and the NAICS code in the USA, for example). This list can be provided by a public contributor (In France, for example, several Internet websites provide all the French firms with SIREN and NAF codes. The information comes from the INSEE, but is not free of charges).

By using this list, the bank can find the sectorial code, corresponding for each expense.

In a second step, the bank has to create a mapping table for each sectorial code to attribute a relevant expense subtype. The bank will use this table to attribute an expense subtype for each expense.

For example, all the expenses with firms having a sectorial code related to telecommunications will receive the subtype “telecom”. All the expenses with firms having a sectorial code related to gas, electricity or water will receive the subtype “utilities”, etc.

In a third step, the bank generates a final expense type or category considering the expense subtype and the amount (positive or negative).

Most of the expense types have only one subtype. But a subtype can be ambiguous (for example an expense in a Virgin Store will have a subtype “Culture OR House equipments”, and will then be mapped with a different expense type, considering the amount of the expense. Above 250 [symbol] the expense will be classified as “House equipments”; below 250 [symbol] it will be classified as “Culture”.

The bank would have to create this table very precisely, considering that there are, for example, 712 NAF codes in France created by the INSEE. For example:

52.1D Supermarkets=>“Food OR House equipments”

52.1F Hypermarkets=>“Food OR House equipments”

52.2A Fruits & vegetables=><<Food>>

52.2C Meat=><<Food>>

52.2E Fish & shells=><<Food>>

52.2G Bread & cakes=><<Food>>

52.2J Bars=>“Bars, cigarettes, papers”

52.2L Tobacco=>“Bars, cigarettes, papers”

52.3A Chemistry shops=><<Health>>

52.3E Beauty=><<Beauty>>

52.4C Clothings=>“Clothings”

52.4E Shoes=>“Clothings”

52.4H Furniture=>“House equipments”

52.4L Domestic appliances & televisions=>“House equipments”

52.4R Papers & books=>“Bars, cigarettes, papers”

It has to be fulfilled and completed by the bank. One expense type or category corresponds with several subtypes, depending of the amount of the expense.

The correlation or mapping between the expense types (or categories) and the subtypes is illustrated in Table 1.

TABLE 1

| | Expense Type | Subtype1 | Min1 | Max1 | Subtype2 | Min2 | Max2 | Subtype3 | Min3 | Max3 | Max2 |
|---|---|---|---|---|---|---|---|---|---|---|---|
| 1 | Salary/pension | All except | 0 | 9999 | | | | | | | |
| | | Health | | | | | | | | | |
| 2 | Rental | Rental | −9999 | 0 | Individuals | −9999 | 0 | | | | |
| 3 | Taxes | Taxes | −9999 | 0 | | | | | | | |
| 4 | Food, | Food | −9999 | 0 | Food OR House | −350 | 0 | | | | |
| | supermarkets | | | | equipments (ex: | | | | | | |
| | | | | | supermarkets) | | | | | | |
| 5 | House | House | −9999 | 0 | Food OR House | −9999 | −350 | Culture OR | −9999 | −250 | |
| | equipments | equipments | | | equipments (ex: | | | House | | | |
| | | | | | supermarkets) | | | equipments | | | |
| | | | | | | | | (ex: Virgin) | | | |
| 6 | Culture | Culture | −9999 | 0 | Culture OR | −250 | 0 | | | | |
| | | | | | House | | | | | | |
| | | | | | equipments | | | | | | |
| | | | | | (ex: Virgin) | | | | | | |
| 7 | Transportation | Transportation | −9999 | 0 | Transportation | −40 | 0 | | | | |
| | | | | | OR Traveling | | | | | | |
| | | | | | (ex: train) | | | | | | |
| 8 | Traveling | Traveling | −9999 | 0 | Transportation | −9999 | −40 | | | | |
| | | | | | OR Traveling | | | | | | |
| | | | | | (ex: train) | | | | | | |
| 9 | Utilities | Utilities | −9999 | 0 | | | | | | | |
| 10 | Telecoms | Telecoms | −9999 | 0 | | | | | | | |
| 11 | Clothings | Clothings | −9999 | 0 | | | | | | | |
| 12 | Insurance | Insurance | −9999 | 0 | | | | | | | |
| 13 | Bars, | Bars, | −9999 | 0 | | | | | | | |
| | cigarettes, | cigarettes, | | | | | | | | | |
| | papers | papers | | | | | | | | | |
| 14 | Health | Health | −9999 | 0 | | | | | | | |
| 15 | Health | Health | 0 | 9999 | | | | | | | |
| | repayments | | | | | | | | | | |
| 16 | Beauty | Beauty | −9999 | 0 | | | | | | | |
| 17 | Restaurants | Restaurants | −9999 | 0 | | | | | | | |
| 18 | Night out | Night out | −9999 | 0 | | | | | | | |
| 19 | Cash | Cash | −9999 | 0 | | | | | | | |
| | withdrawals | withdrawals | | | | | | | | | |

### Example

Mr Smith buys a television at Auchan (hypermarket) at 455 [symbol] by credit card. The bank of Mr Smith receives a confirmation from the bank of Auchan:

### Name: Auchan

Siren code: 410409460

### Amount: 455

At the end of the quarter, the disclosed process includes:
STEP 1: In the list provided by the INSEE, the SIREN code: 410409460 is associated with the Name “Auchan” and with the sectorial NAF code: 521F—Hypermarket.
STEP 2: In the table “Mapping of the NAF Codes” created by the bank, the NAF Code 521F is mapped with the expense subtype: “Food OR House equipments”. The expense subtype has been created because this category of store can generate food expenses or house equipment expenses. The choice between both will be made in the third step.
STEP 3: In the table <<Mapping subtypes>>, the expense subtype is mapped with the expense type “House equipments” because the amount is above 350 [symbol] -below 350 [symbol] the expense type would have been “Food, supermarkets”.
This is why Mr Smith can read in its quarter reporting in the category “House equipments” an expense of 455 [symbol] made at Auchan (please see presentation above).

The expenses accumulated by the banks may be credit cards operations, cash withdrawals, checks, transfers, automated payments or other payments means.

SIREN and NAF codes are French codes. The names of the codes will differ in other countries.

The SIREN code is the HR number in Germany, the CIF/NIF in Spain, the CCIAA in Italy.

The NAF code is the WZ in Germany, the CNAE in Spain, the ATECO in Italy.

If the expense comes from an individual person, the SIREN code will be replaced by its personal identification number (the SS number in France), and then the sectorial NAF sector will be “individuals”.

The process may not be perfect and generate some misclassification of the expenses—especially for expenses in generic and large stores. This is why it may be recommended to send to the client an electronic version of the expenses report, in order that it may be able to reclassify a few expenses by himself, if he detects a mistake in the classification.

The electronic report can be for example: a Microsoft Excel spreadsheet, a Microsoft Money file, or another format. The electronic report can also be made through a dedicated website or a dedicated part of the bank's website for the banks customers.

Additionally, the bank can indicate for each expense's classification if this classification may be wrong or uncertain.

The presentation of the expenses (above) suggests that the bank can compare the expenses of its client with the expenses of the last quarter, but also with the average expenses for a citizen with same gender, same age, same family situation and same worker category. The bank would find these average expenses through public data (these data are free on the website of the INSEE in France, for example).

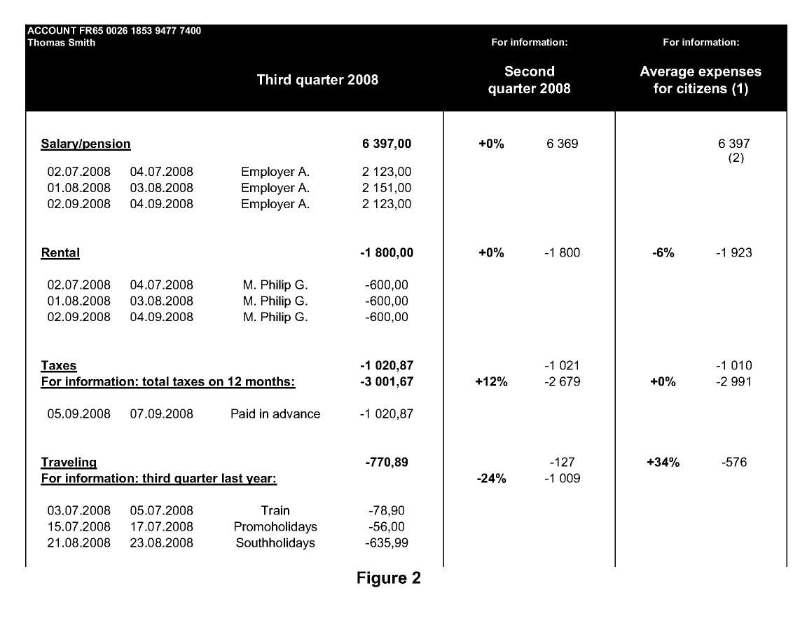

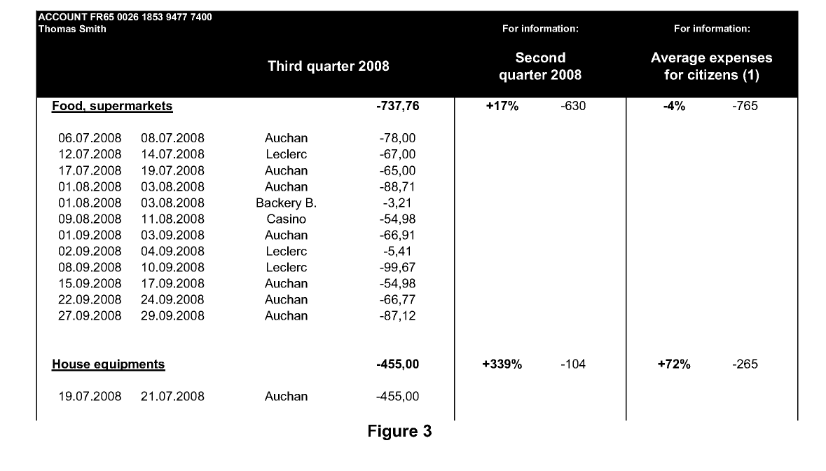

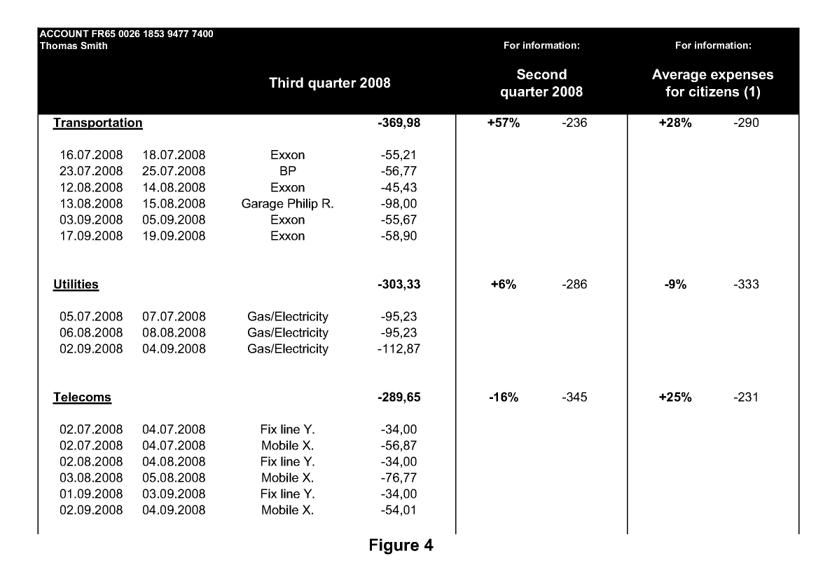

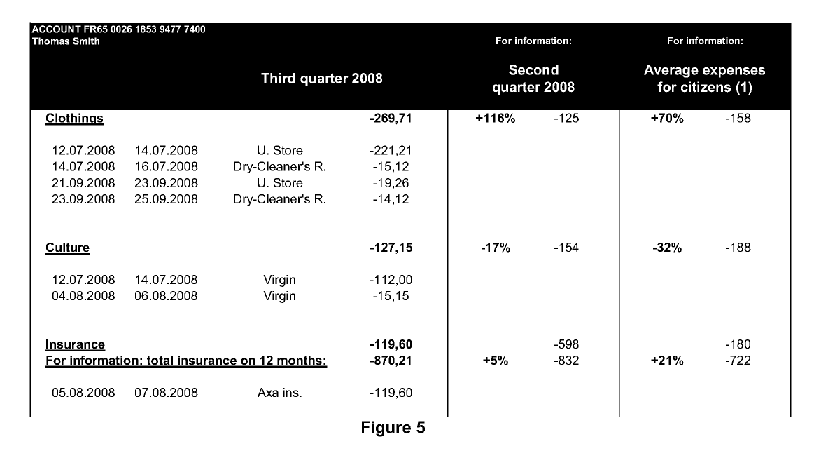

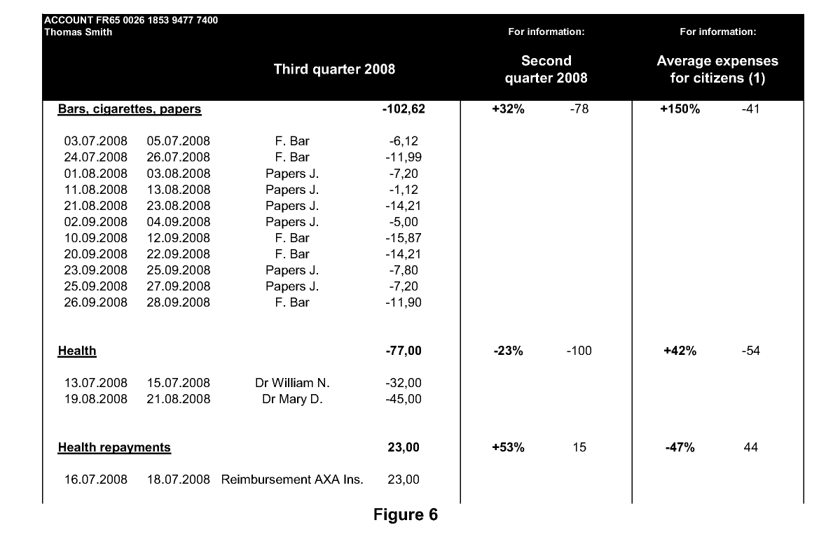

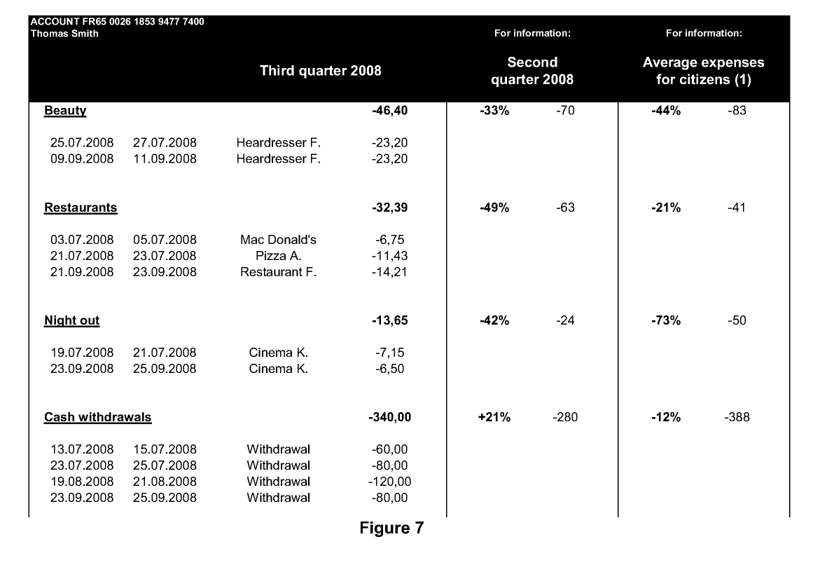

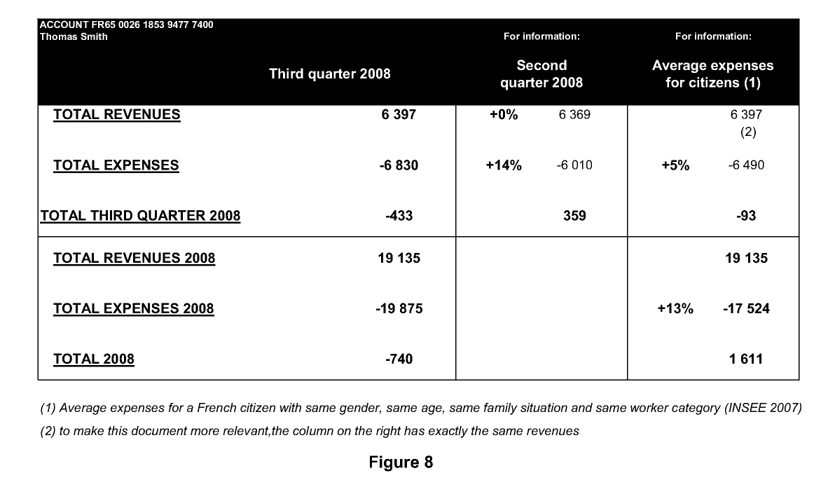

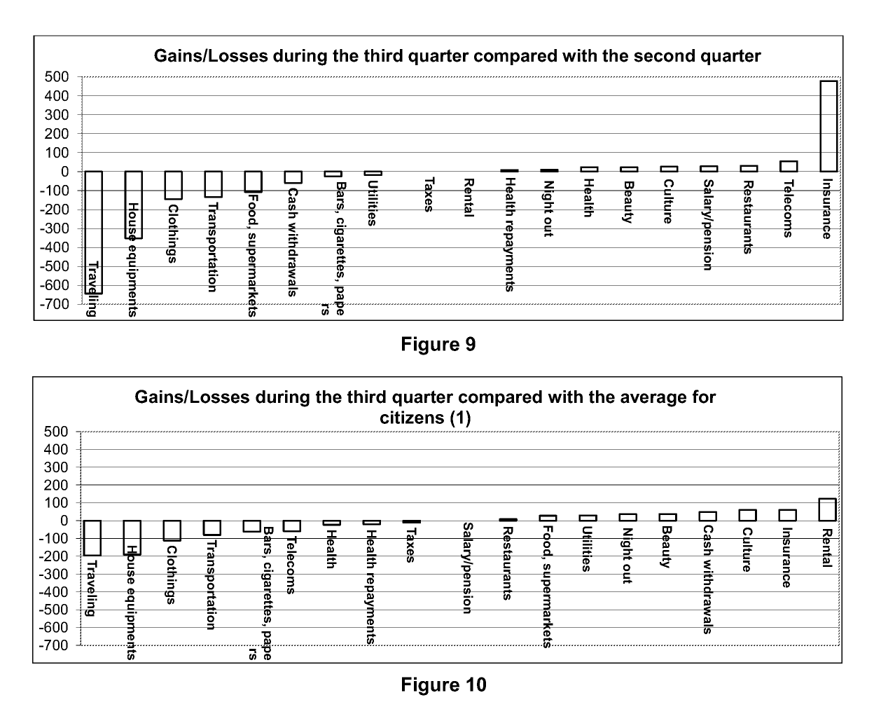

The disclosed process allows the bank to generate automatically this kind of reports every quarter as illustrated in FIGS. 2, 3 and 4 where an analytical presentation of the expenses of an individual is presented. FIGS. 2, 3 and 4 form a single report for the third quarter of 2008. The transactions of this period are classified by categories or expense types, like “Salary/pension”, “Rental”, “Taxes”, . . . , and listed in the left column. The sums of these transactions of this period and for each type are also represented (in bold). Additionally, two additional optional columns are present for additional information purposes only. The left column indicates the variation in percent for each type in relation with the previous period, i.e. in this case for the second quarter 2008. The right column indicates for each type a comparison expressed in percent with the corresponding transactions of an average citizen. At the bottom of the report, the total of the revenues and the total of the expenses are presented as well as the difference between these two amounts. For even more clarity, the variations of the different summed transactions by type or category compared with the previous period are presented in a histogram. The same is done for the variations of the same summed transactions by type or category compared with an average citizen. Eventually, the total revenues and total expenses for the year to date and the difference between these two amounts are also presented at the very bottom of the report. This provides to the bank account holder a very clear overview of his financial situation.

According to the present disclosure, banks can create a new service for their clients. The bank would execute, for example, quarterly all the data treatments in order to deliver automatically a complete and analytical overview of the client expenses, and send this report to the client by mail and/or email.

This way, the client can try to manage its expenses with a better global overview. The client can have a chronological view of its expenses, and can compare its expenses with a “virtual person” who would have the same profile.

According to the present disclosure, banks can provide a new service to every customer, especially those who can hardly deal with expenses management or those who are over indebted.

Processes disclosed herein can be carried out by a computer program. Here is an example of such a program:

Procedure
// This is the main program, which outputs the analytical view of the expenses. This
program calls the sub-program that outputs the expenses of the << i >> type, for a specific
quarter, and it calls the sub-function that outputs the sum of these amounts.
For i = 1 to N
// For each expense type, the value of the sub-function << Expenses_Subtype >> for the
third quarter and for the three subtypes corresponding in the table
<< Mapping_subtypes >> described earlier.
Expenses = Expenses_Subtype (20080701, 20081001,
Mapping_subtypes(i).Subtype1, Mapping_subtypes(i).Min1, Mapping_subtypes(i).Max1,
Mapping_subtypes(i).Subtype2, Mapping_subtypes(i).Min2, Mapping_subtypes(i).Max2,
Mapping_subtypes(i).Subtype3, Mapping_subtypes(i).Min3, Mapping_subtypes(i).Max3)
// The value is saved in the array << Save_Expenses >> where all the expenses for each
quarter and for each expense type will be saved.
Save_Expenses (i,2008_Q3)= Expenses
// The value is compared with the value of the last quarter and with the value for the
average expenses for citizens from the array << Save_Expenses_Average >>.
Compare (Mapping_subtypes(i).Subtype1, Save_Expenses (i, 2008_Q3),
Save_Expenses (i,2008_Q2), Save_Expenses_Average (i,2008_Q3))
// For the expenses types << Taxes >> and << Insurance >> the sum of the values on one
year is compared with the sum on one year of the last quarter and with the sum on one
year for the average expenses for citizens.
If Mapping_subtypes(i).Subtype1=”Taxes” or
Mapping_subtypes(i).Subtype1=”Insurance” then
Compare_Years ( Mapping_subtypes(i).Subtype1,
Save_Expenses (i,2008_Q3)+Save_Expenses (i,2008_Q2)+Save_Expenses
(i,2008_Q1)+Save_Expenses (i,2007_Q4),
Save_Expenses (i,2008_Q2)+Save_Expenses (i,2008_Q1)+Save_Expenses
(i,2007_Q4)+Save_Expenses (i,2007_Q3),
Save_Expenses_Average (i, 2008_Q3)+Save_Expenses_Average (i, 2008_Q2)
+Save_Expenses_Average (i, 2008_Q1)+Save_Expenses_Average (i, 2007_Q4))
// For the expenses type << Traveling >> the value is compared with the value for last year
at the same quarter.
If Mapping_subtypes(i).Subtype1=”Traveling” then
Compare (Mapping_subtypes(i).Subtype1, Save_Expenses (i, 2008_Q3),
Save_Expenses (i,2007_Q3),0)
// For each expense type all the corresponding expenses subtypes are shown.
Print_Expenses_Subtype (20080701, 20081001,
Mapping_subtypes(i).Subtype1, Mapping_subtypes(i).Min1, Mapping_subtypes(i).Max1,
Mapping_subtypes(i).Subtype2, Mapping_subtypes(i).Min2, Mapping_subtypes(i).Max2,
Mapping_subtypes(i).Subtype3, Mapping_subtypes(i).Min3, Mapping_subtypes(i).Max3)
End For
// After the expenses types, the same is made for the cash withdrawals.
Expenses = Expenses_Cash (20080701, 20081001)
Save_Expenses (N+1,2008_Q3)= Expenses
Compare (“Retraits Cash”, Save_Expenses (N+1, 2008_Q3), Save_Expenses
(N+1,2008_Q2), Save_Expenses_Average (N+1,2008_Q3))
Print_Cash (20080701, 20081001)
// End of the main program.
End Procedure
// The first sub-program outputs the expenses between two dates, for three expenses
subtypes, with specific minimum and maximum amounts for each subtypes.
Procedure Print_Expenses_Subtype( Date1, Date2, Subtype1, Min1, Max1, Subtype2,
Min2, Max2, Subtype3, Min3, Max3)
// A query is made with the corresponding criteria in the credit cards expenses
database.
Query_CreditCard =”Extract
CreditCard.InputDate,
CreditCard.TransferDate,
CreditCard.Name,
CreditCard.Amount
From CreditCard, Mapping
Where CreditCard.SIREN=Mapping.SIREN
and
or (Mapping.Mapping_subtypes = Subtype1 and CreditCard.Amount < Max1
CreditCard.Amount > Min1, Mapping.Mapping_subtypes = Subtype2 and
CreditCard.Amount *< Max2 CreditCard.Amount > Min2, Mapping.Mapping_subtypes =
Subtype3 and CreditCard.Amount < Max3 CreditCard.Amount > Min3)
and CreditCard.InputDate<Date2
and CreditCard.InputDate>=Date1;”
// Then a query is made with the corresponding criteria in the checks expenses
database.
Query_Checks =”Extract
Checks.InputDate,
Checks.TransferDate,
Checks.Name,
Checks.Amount
From Checks, Mapping
Where Checks.SIREN=Mapping.SIREN
and
or (Mapping.Mapping_subtypes = Subtype1 and Checks.Amount < Max1
Checks.Amount > Min1,
Mapping.Mapping_subtypes = Subtype2 and Checks.Amount < Max2 Checks.Amount >
Min2,
Mapping.Mapping_subtypes = Subtype3 and Checks.Amount < Max3 Checks.Amount >
Min3)
and Checks.InputDate<Date2
and Checks.InputDate>=Date1;”
// Then a query is made with the corresponding criteria in the automated payments
expenses database.
Query_Autopayment =”Extract
Autopayment.InputDate,
Autopayment.TransferDate,
Autopayment.Name,
Autopayment.Amount
From Autopayment, Mapping
Where Autopayment.SIREN=Mapping.SIREN
and
or (Mapping.Mapping_subtypes = Subtype1 and Autopayment.Amount < Max1
Autopayment.Amount > Min1, Mapping.Mapping_subtypes = Subtype2 and
Autopayment.Amount < Max2 Autopayment.Amount > Min2,
Mapping.Mapping_subtypes = Subtype3 and Autopayment.Amount < Max3
Autopayment.Amount > Min3)
and Autopayment.InputDate<Date2
and Autopayment.InputDate>=Date1;”
// The three queries are added. There would be more queries in case of additional
payments means.
Query = Query_CreditCard & Query_Checks & Query_Autopayment
Print_expenses (Query)
End Procedure // End of the first sub-program.
// The first sub-function outputs the sum of the expenses between two dates, for three
expenses subtypes, with specific minimum and maximum amounts for each subtypes.
Function Expenses_Subtype (Date1, Date2, Subtype1, Min1, Max1, Subtype2, Min2,
Max2, Subtype3, Min3, Max3)
// A query is made with the corresponding criteria in the credit cards expenses
database.
Sum_CreditCard =”Sum
CreditCard.Amount
From CreditCard, Mapping
Where CreditCard.SIREN=Mapping.SIREN
and
or (Mapping.Mapping_subtypes = Subtype1 and CreditCard.Amount < Max1
CreditCard.Amount > Min1, Mapping.Mapping_subtypes = Subtype2 and
CreditCard.Amount < Max2 CreditCard.Amount > Min2, Mapping.Mapping_subtypes =
Subtype3 and CreditCard.Amount < Max3 CreditCard.Amount > Min3)
and CreditCard.InputDate<Date2
and CreditCard.InputDate>=Date1;”
// Then a query is made with the corresponding criteria in the checks expenses
database.
Sum _Checks =”Sum
Checks.Amount
From Checks, Mapping
Where Checks.SIREN=Mapping.SIREN
and
or (Mapping.Mapping_subtypes = Subtype1 and Checks.Amount < Max1
Checks.Amount > Min1,
Mapping.Mapping_subtypes = Subtype2 and Checks.Amount < Max2 Checks.Amount >
Min2,
Mapping.Mapping_subtypes = Subtype3 and Checks.Amount < Max3 Checks.Amount >
Min3)
and Checks.InputDate<Date2
and Checks.InputDate>=Date1;”
// Then a query is made with the corresponding criteria in the automated payments
expenses database.
Sum_Autopayment =”Sum
Autopayment.Amount
From Autopayment, Mapping
Where Autopayment.SIREN=Mapping.SIREN
and
or (Mapping.Mapping_subtypes = Subtype1 and Autopayment.Amount < Max1
Autopayment.Amount > Min1, Mapping.Mapping_subtypes = Subtype2 and
Autopayment.Amount < Max2 Autopayment.Amount > Min2,
Mapping.Mapping_subtypes = Subtype3 and Autopayment.Amount < Max3
Autopayment.Amount > Min3)
and Autopayment.InputDate<Date2
and Autopayment.InputDate>=Date1;”
// The three queries are added. There would be more queries in case of additional
payments means.
Expenses_Subtype = Sum_Autopayment +Sum_Cheks + Sum_Autopayment
End Function // End of the first sub-function.
// The second sub-program outputs the cash withdrawals between two dates.
Procedure Print_Cash( Date1, Date2)
// There is only one query.
Query_Cash =”Extract
Cash.InputDate,
Cash.TransferDate,
Cash.Name,
Cash.Amount
From Cash
Where Cash.InputDate<Date2
And Cash.InputDate>=Date1;”
Print_expenses (Query_Cash)
End Procedure // End.
// The second sub-function outputs the sum of the cash withdrawals between two dates.
Function Expenses_Cash( Date1, Date2)
// There is only one query.
Expenses_Cash = ”Sum
Cash.Amount
From Cash
Where Cash.InputDate<Date2
and Cash.InputDate>=Date1;”
End Function // End.

It is apparent that an invention with significant advantages has been described and illustrated. Although the present application is shown in a limited number of forms, it is not limited to just these forms, but is amenable to various changes and modifications without departing from the spirit thereof.

What is claimed is:

1. A method for automatically classifying a transaction made on a bank account with a debtor or creditor firm, the method comprising:
identifying the public registration code of the firm with which the money transfer is made, the code being a unique identification code of the firm and available to the transaction data;
identifying a public sectorial code of the firm which identifies the sectorial activity of the firm;
mapping the transaction with the identification code and the sectorial code; and
assigning a category to the transaction based on the sectorial code assigned thereto.

2. A method according to claim 1, wherein a category list is mapped with a public sectorial code list in order to automatically assign a category to each transaction.

3. A method according to claim 2, wherein the mapping between some sectorial codes and some categories is conditioned by the amount of the transaction and/or the debit or credit nature of the transaction.

4. A method according to claim 1, wherein a subtype list is mapped with a public sectorial code list and the automatic assignment of a category to a transaction is based on the subtype assigned to the transaction.

5. A method according to claim 4, wherein a category list is mapped with the subtype list.

6. A method according to claim 5, wherein the mapping between the category list and the subtype list is dependent on the amount of the transaction and/or the debit or credit nature of the transaction.

7. A method according to claim 6, wherein the transactions are debits of the bank account representing the expenses of the account's holder.

8. A method according to claim 6, wherein the transactions comprise credit/debit card payments, electronic payments, transfers and automated payments.

9. A method according to claim 6 comprising the additional step of summing by category the amounts of the transactions for a predetermined period of time.

10. A method according to claim 9, wherein the sums of the transactions by category are compared with the corresponding sums of one or more preceding periods.

11. A method according to claim 9, wherein the sums of the transactions by category are compared with corresponding average results.

12. A method according to claim 11, wherein the average results to which the sums of the transactions are compared by category correspond to the summed transactions of a virtual average person sharing with the bank account's holder a series of features.

13. A method according to claim 12, wherein the features shared with the virtual average person are comprised in the following none exhaustive list: age, gender, professional activity category, family situation, place of living, health state.

14. A method according to claim 11, wherein the comparison between the sums of the transactions by category with corresponding amounts is expressed by means of at least a number and/or a sign for each category.

15. A method according to claim 1, comprising the additional step that an electronic report is generated and that the categorizing of the transactions can be manually modified.

16. A method according to claim 1, comprising the additional step that the bank can indicate for each expense's classification if this classification may be wrong or uncertain.
